(19) United States
(12) Patent Application Publication
(10) Pub. No.: US 2023/0027841 A1
(43) Pub. Date: Jan. 26, 2023

(54) Methods for shortening latency associated with UL traffic transmission and communications apparatus utilizing the same

(71) Applicant: MEDIATEK INC., Hsin-Chu (TW)

(72) Inventors: Chiao-Chih Chang, Hsinchu City (TW); Jianwei Zhang, Beijing (CN); Yu-Po Wang, Hsinchu City (TW); Jun-Jie Su, Hsinchu City (TW)

(73) Assignee: MEDIATEK INC., Hsin-Chu (TW)

(21) Appl. No.: 17/857,183

(22) Filed: Jul. 5, 2022

Related U.S. Application Data
(60) Provisional application No. 63/224,526, filed on Jul. 22, 2021.

(30) Foreign Application Priority Data
Jun. 6, 2022 (CN) 202210634518.5

(51) Int. Cl. H04W 72/12; H04W 72/14

(52) U.S. Cl. CPC H04W 72/1268; H04W 72/14; H04W 72/1289

(57) ABSTRACT

A communications apparatus includes a radio transceiver transmitting or receiving wireless signals in a wireless network and a processor coupled to the radio transceiver. The processor is configured to perform operations comprising: transmitting pre-schedule mechanism assistance information to a network device in the wireless network for the network device to refer to for uplink (UL) resource allocation regarding a pre-schedule mechanism; receiving one or more uplink (UL) grants from the network device; and performing UL transmission to the network device responsive to receiving the one or more UL grants.

### CROSS REFERENCE TO RELATED APPLICATIONS

This application claims the benefit of U.S. Provisional Application No. 63/224,526, filed on Jul. 22, 2021. The content of the application is incorporated herein by reference.

### BACKGROUND

Under the 3rd Generation Partnership Project (3GPP) specifications, a UE sends one or more scheduling requests (SRs) to a base station (e.g., eNB or gNB) when there is uplink (UL) traffic (e.g., data packets) to be transmitted by the UE. In response, the base station replies with an UL grant for the UE to transmit the UL traffic. However, there is typically a delay between the time the UE sends the SR(s) and the time the UE receives the UL grant and, hence, there is usually a latency associated with UL traffic transmission.

To shorten the latency, one approach would be to make improvement on the network side with a short cut with respect to forwarding traffic for packet transmission. Alternatively, another approach would be for the network to recognize the Subscriber Identity Module (SIM) card of a UE and provide low-latency mode for that UE. Nevertheless, such approaches would require support from the internet service provider (ISP), which can be costly for the end user.

In view of this, solutions for shortening latency associated with UL traffic transmission are highly required.

### SUMMARY

An objective of the disclosure aims to provide schemes, solutions, concepts, designs, methods and systems pertaining to improvement on UE uplink latency in wireless communications. In particular, the disclosure aims to provide cost-effective, power-effective and resource-effective solutions to achieve improvement on UE uplink latency in wireless communications.

According to an embodiment of the invention, a communications apparatus comprises a radio transceiver transmitting or receiving wireless signals in a wireless network and a processor coupled to the radio transceiver. The processor is configured to perform operations comprising: transmitting pre-schedule mechanism assistance information to a network device in the wireless network for the network device to refer to for uplink (UL) resource allocation regarding a pre-schedule mechanism; receiving one or more UL grants from the network device; and performing UL transmission to the network device responsive to receiving the one or more UL grants.

According to another embodiment of the invention, a method for shortening latency associated with UL traffic transmission comprises: transmitting, by a communications apparatus, pre-schedule mechanism assistance information to a network device in a wireless network for the network device to refer to for uplink (UL) resource allocation regarding a pre-schedule mechanism; receiving, by the communications apparatus, one or more UL grants from the network device; and performing, by the communications apparatus, UL transmission to the network device responsive to receiving the one or more UL grants.

According to yet another embodiment of the invention, a method for shortening latency associated with UL traffic transmission of a communications apparatus communicating with a network device in a wireless network, comprises: receiving, by the network device, pre-schedule mechanism assistance information from the communications apparatus; performing, by the network device, uplink (UL) resource allocation for the communications apparatus with the knowledge of the pre-schedule mechanism assistance information; and transmitting, by the network device, one or more UL grants to the communications apparatus based on the UL resource allocation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an exemplary communications environment having a communications apparatus and a network device according to an embodiment of the invention.

FIG. 2 illustrates an exemplary block diagram of a modem according to an embodiment of the invention.

FIG. 3 illustrates an example scenario of a conventional approach of resource scheduling.

FIG. 4 illustrates an exemplary flow chart of a method for shortening latency associated with UL traffic transmission according to an embodiment of the invention.

FIG. 5 is an exemplary message flow illustrating negotiation of the pre-schedule mechanism assistance information support capability and transmission of the pre-schedule mechanism assistance information according to an embodiment of the invention.

FIG. 6 illustrates an example scenario of resource scheduling associated with the proposed scheme according to an embodiment of the invention.

FIG. 7 is a schematic diagram showing the exemplary relations between the UE's behaviors and the latency requirements and the corresponding operations at the network side upon receiving the pre-schedule mechanism assistance information.

FIG. 8 illustrates an exemplary flow chart of a method for optimizing latency requirement based on detection of application scenario implemented at the UE side according to an embodiment of the invention.

FIG. 9 illustrates an exemplary flow chart of a method for optimizing latency requirement based on detection of application scenario implemented at the Node B side according to an embodiment of the invention.

### DETAILED DESCRIPTION

Implementations in accordance with the disclosure relate to various techniques, methods, schemes and/or solutions pertaining to improvement on UE uplink latency in wireless communications. According to the disclosure, a number of possible solutions may be implemented separately or jointly. That is, although these possible solutions may be described below separately, two or more of these possible solutions may be implemented in one combination or another.

Under various schemes proposed in the disclosure, latency of network traffic between a UE and a base station may be shortened or otherwise improved. The term “latency” herein may refer to “uplink latency” or “round trip latency” of UE. The “uplink latency” may refer to the lapse in time between the time data for uplink transmission arrives at layer 2 (L2) of a UE and the time of uplink transmission of such data. The “round trip latency” may refer to the lapse in time between the time data for uplink transmission arrives at layer 2 (L2) of a UE and the time a downlink response message from the base station for responding to the uplink data is received by the UE. In other words, the “round trip latency” may further include air latency.

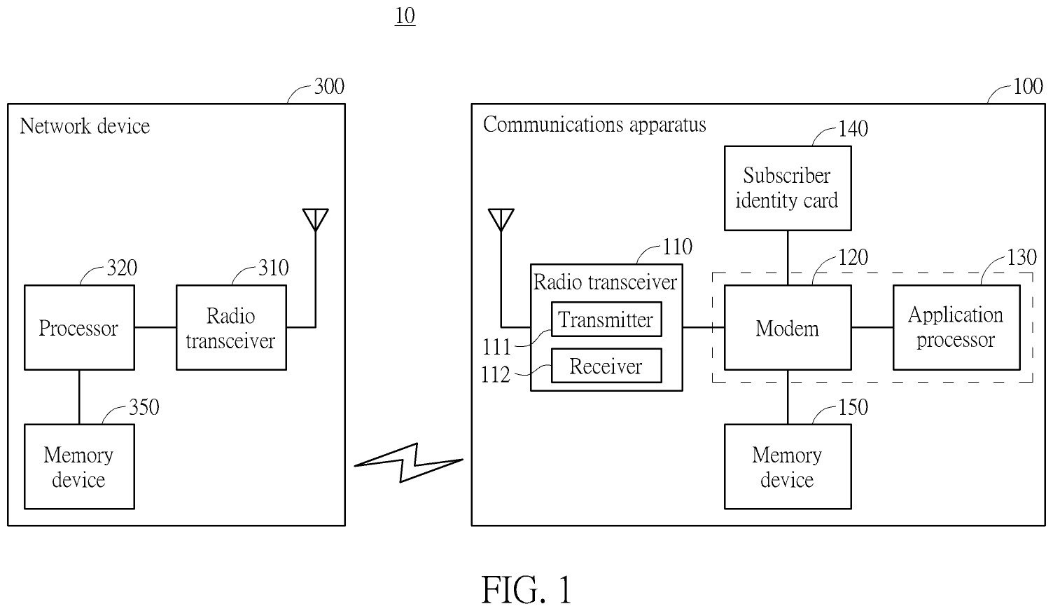

FIG. 1 illustrates an exemplary communications environment 10 having a communications apparatus 100 and a network device 300 according to an embodiment of the invention. The communications apparatus 100 may be a portable electronic device, such as a Mobile Station (MS, which may be interchangeably referred to as User Equipment (UE)). The communications apparatus 100 may comprise at least an antenna module comprising at least one antenna, a radio transceiver 110, a modem 120, an application processor 130, a subscriber identity card 140, and a memory device 150.

The radio transceiver 110 may comprise a receiver 112 configured to receive wireless signals from an air interface via the antenna module and a transmitter 111 configured to transmit wireless signals to the air interface via the antenna module, and the radio transceiver 110 may be configured to perform RF signal processing. For example, the receiver 112 may convert the received signals into intermediate frequency (IF) or baseband signals to be processed, or transmitter 111 may receive the IF or baseband signals from the modem 120 and convert the received signals into wireless signals to be transmitted to the air interface. The wireless signals transmitted by the transmitter 111 of the communications apparatus 100 may be received by the network device 300 in the communications environment 10 of a wireless network, and the wireless signals transmitted by the network device 300 may be received by the receiver 112 of the communications apparatus 100.

According to an embodiment of the invention, the transmitter 111 and the receiver 112 of the radio transceiver 110 may comprise a plurality of hardware devices to perform radio frequency (RF) conversion and RF signal processing. For example, the transmitter 111 and/or the receiver 112 may comprise a power amplifier for amplifying the RF signals, a filter for filtering unwanted portions of the RF signals and/or a mixer for performing radio frequency conversion. According to an embodiment of the invention, the radio frequency may be, for example, the frequency of any specific frequency band for a LTE system, or the frequency of any specific frequency band for a 5G NR system, the frequency of any specific frequency band for a WiFi system, etc.

The modem 120 may be configured to handle corresponding communications protocol operations and processing the IF or baseband signals received from or to be transmitted to the radio transceiver 110. The application processor 130 is configured to run the operating system of the communications apparatus 100 and run application programs installed in the communications apparatus 100. In the embodiments of the invention, the modem 120 and the application processor 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a SIM, USIM, R-UIM or CSIM card, or the like and may typically contain user account information, an International Mobile Subscriber Identity (IMSI) and a set of SIM application toolkit (SAT) commands and may provide storage space for phone book contacts. The memory device 150 may be coupled to the modem 120 and application processor 130 and may store system data or user data.

The network device 300 may be a device in a wireless access network (e. g. a cellular network or a wireless local access network). According to an embodiment of the invention, the network device 300 may be a cell, a node B, an evolved node B (eNB), a g node B (gNB), a base station, a Mobility Management Entity (MME), an Access and Mobility Management Function (AMF) device, an access point (AP), etc., at the network side.

The network device 300 may at least comprise a radio transceiver 310, a processor 320 and a memory device 350. The radio transceiver 310 is configured to receive and transmit wireless signals. The memory device 350 may be coupled to the processor 320 and is configured to be accessed by processor 320 and store data therein.

The network device 300 and the communications apparatus 100 may wirelessly communicate with each other via radio transceiver 310 and radio transceiver 110 respectively. as described above

It should be noted that, in order to clarify the concept of the invention, FIG. 1 presents a simplified block diagram in which only the elements relevant to the invention are shown. For example, in some embodiments of the invention, a communications apparatus may further comprise some peripheral devices not shown in FIG. 1. In another example, in some embodiments of the invention, a communications apparatus may further comprise a central controller coupled to the modem 120 and the application processor 130. Therefore, the invention should not be limited to what is shown in FIG. 1.

In some embodiments of the invention, the communications apparatus 100 is capable of supporting multiple radio access technologies (RATs) communications via the single-card structure as shown in FIG. 1. It should be noted that, although FIG. 1 shows a single-card application, the invention should not be limited thereto. For example, in some embodiments of the invention, the communications apparatus 100 may comprise multiple subscriber identity cards to support the multi-RATs communications, in either a single-standby or a multiple-standby manner. In the multi-RATs communications applications, the modem, the radio transceiver and/or the antenna module may be shared by the subscriber identity card(s) and may have the capability of handling the operations of different RATs and processing the corresponding RF, IF or baseband signals in compliance with the corresponding communications protocols.

In addition, those who are skilled in this technology can still make various alterations and modifications based on the descriptions given above to derive the communications apparatuses comprising multiple radio transceivers and/or multiple antenna modules for supporting multi-RAT wireless communications without departing from the scope and spirit of this invention. Therefore, in some embodiments of the invention, the communications apparatus may be designed to support a multi-card application, in either a single-standby or a multiple-standby manner, by making some alterations and modifications.

It should be further noted that the subscriber identity card 140 may be dedicated hardware cards as described above, or in some embodiments of the invention, there may be individual identifiers, numbers, addresses, or the like which are burned in the internal memory device of the corresponding modem and are capable of identifying the communications apparatus 100. Therefore, the invention should not be limited to what is shown in the figures.

It should be further noted that in some embodiments of the invention, the communications apparatus 100 may further support multiple IMSIs.

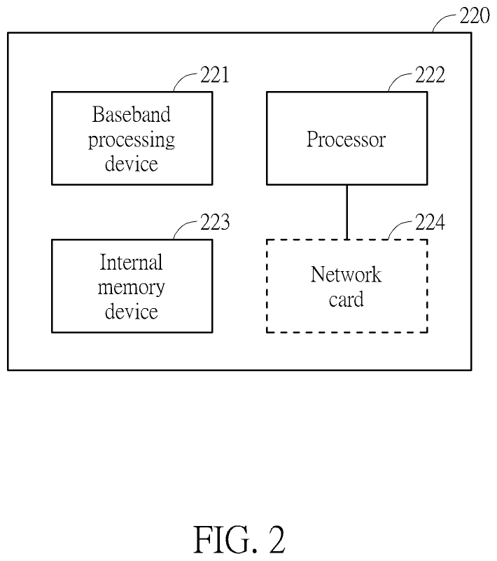

FIG. 2 illustrates an exemplary block diagram of a modem according to an embodiment of the invention. The modem 220 may be the modem 120 shown in FIG. 1 and may comprise at least a baseband processing device 221, a processor 222, an internal memory device 223 and a network card 224. The baseband processing device 221 may receive the IF or baseband signals from the radio transceiver 110 and perform IF or baseband signal processing. For example, the baseband processing device 221 may convert the IF or baseband signals into a plurality of digital signals, and process the digital signals, and vice versa. The baseband processing device 221 may comprise a plurality of hardware devices to perform signal processing, such as an analog-to-digital converter for ADC conversion, a digital-to-analog converter for DAC conversion, an amplifier for gain adjustment, a modulator for signal modulation, a demodulator for signal demodulation, an encoder for signal encoding, a decoder for signal decoding, and so on.

According to an embodiment of the invention, the baseband processing device 221 may be designed to have the capability of handling the baseband signal processing operations for different RATs and processing the corresponding IF or baseband signals in compliance with the corresponding communications protocols, so as to support the multi-RAT wireless communications. According to another embodiment of the invention, the baseband processing device 221 may comprise a plurality of sub-units, each being designed to have the capability of handling the baseband signal processing operations of one or more specific RATs and processing the corresponding IF or baseband signals in compliance with the corresponding communications protocols, so as to support the multi-RAT wireless communications. Therefore, the invention should not be limited to any specific way of implementation.

The processor 222 may control the operations of the modem 220. According to an embodiment of the invention, the processor 222 may be arranged to execute the program codes of the corresponding software module of the modem 220. The processor 222 may maintain and execute the individual tasks, threads, and/or protocol stacks for different software modules. In an embodiment, a protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

The processor 222 may also read data from the subscriber identity card coupled to the modem, such as the subscriber identity card 140, and write data to the subscriber identity card. The internal memory device 223 may store system data and user data for the modem 220. The processor 222 may also access the internal memory device 223.

The network card 224 provides Internet access services for the communications apparatus. It should be noted that, although the network card 224 shown in FIG. 2 is configured inside of the modem, the invention should not be limited thereto. In some embodiments of the invention, the communications apparatus may also comprise a network card configured outside of the modem, or the communications apparatus may also be coupled to an external network card for providing Internet access services. In some embodiments of the invention, the network card 224 may be a virtual network card, instead of a tangible card, that is created by the operating system of the communications apparatus 100. Therefore, the invention should not be limited to any specific implementation method.

It should be noted that, in order to clarify the concept of the invention, FIG. 2 presents simplified block diagrams in which only the elements relevant to the invention are shown. Therefore, the invention should not be limited to what is shown in FIG. 2.

It should be further noted that in some embodiments of the invention, the modem may also comprise more than one processor and/or more than one baseband processing device. For example, the modem may comprise multiple processors and/or multiple baseband processing devices for supporting multi-RAT operations. Therefore, the invention should not be limited to what is shown in FIG. 2.

It should be further noted that in some embodiments of the invention, the baseband processing device 221 and the processor 222 may be integrated into one processing unit, and the modem may comprise one or multiple such processing units, for supporting multi-RAT operations. Therefore, the invention should not be limited to what is shown in FIG. 2.

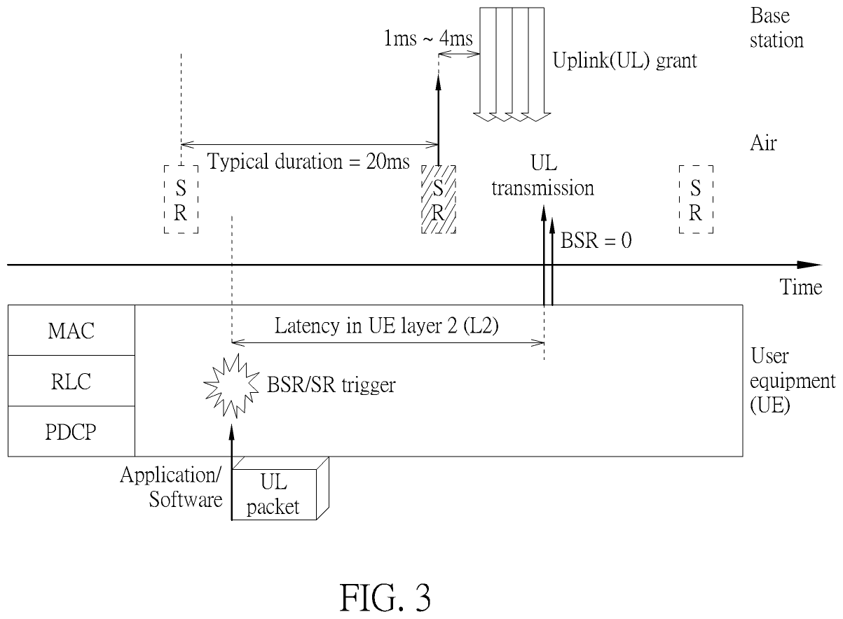

FIG. 3 illustrates an example scenario of a conventional approach of resource scheduling for comparison and to aid better appreciation of advantages and benefits associated with the proposed scheme. Under the conventional approach, a UE is triggered to transmit an SR and/or Buffer Status Report (BSR) when there is user data available for UL transmission (e.g., by the user data arriving at layer 2 of a modem of the UE through the Packet Data Convergence Protocol (PDCP) layer and the Radio Link Control (RLC) layer, such as the UL packet comes from the application/software shown in FIG. 3). Under the conventional approach, time slots for transmission of SRs are typically pre-arranged. For instance, the duration between the transmission of two adjacent SRs is typically 20 milliseconds (ms). Once the UE transmits an SR, a base station may keep sending UL grants to the UE until the UE transmits a zero BSR (with value=0 in the BSR).

However, as described above, there is typically a delay between the time the UE sends the SR(s) and the time the UE receives the UL grant and, hence, there is usually a latency associated with UL traffic transmission, such as the latency in UE layer 2 (L2) shown in FIG. 3.

To shorten the latency, another approach would be to make improvement on the network side with a pre-schedule mechanism. When the pre-schedule mechanism is applied, the base station may schedule one or more UL grants and send the UL grants to the UE regardless of whether the UE actually requires the resources for UL transmission. However, the pre-scheduling of UL grants inevitably increases the power consumption at both the UE side and the bases station side, and also wastes the radio resources of the bases station when the UE does not have any actual UL data transmission request.

In this disclosure, schemes with respect to improvement on UE uplink latency in wireless communications are proposed.

According to an embodiment of the invention, the communications apparatus 100 (e.g. the UE) may actively transmit pre-schedule mechanism assistance information to the network device 300 (e.g. the base station) in the wireless network for improving performance of the pre-schedule mechanism. Unlike the approach in which the base station applies the pre-schedule mechanism with no consideration of UE's behavior, in the proposed schemes, the communications apparatus 100 may provide the pre-schedule mechanism assistance information to the network device for the network device to refer to for uplink (UL) resource allocation regarding a pre-schedule mechanism. In an embodiment of the invention, the pre-schedule mechanism assistance information may include an enable indicator as a suggestion for requesting the enablement or disablement of the pre-schedule mechanism. In addition, in an embodiment of the invention, the pre-schedule mechanism assistance information may further include resource allocation assistance information for the network device to refer to for UL resource allocation when pre-schedule mechanism is enabled. In the proposed schemes, the communications apparatus 100 may also provide preferred transmission parameters associated with UL traffic transmission in the pre-schedule mechanism assistance information as a suggestion to the network device to achieve further improvement on the pre-schedule mechanism. With the pre-schedule mechanism assistance information provided by the communications apparatus 100, the network device 300 may schedule the UL grants more flexible and intelligent with the knowledge of UE's behavior and/or preference. In this manner, not only improvement on UE uplink latency, but also improvement on power consumption and resource waste are achieved.

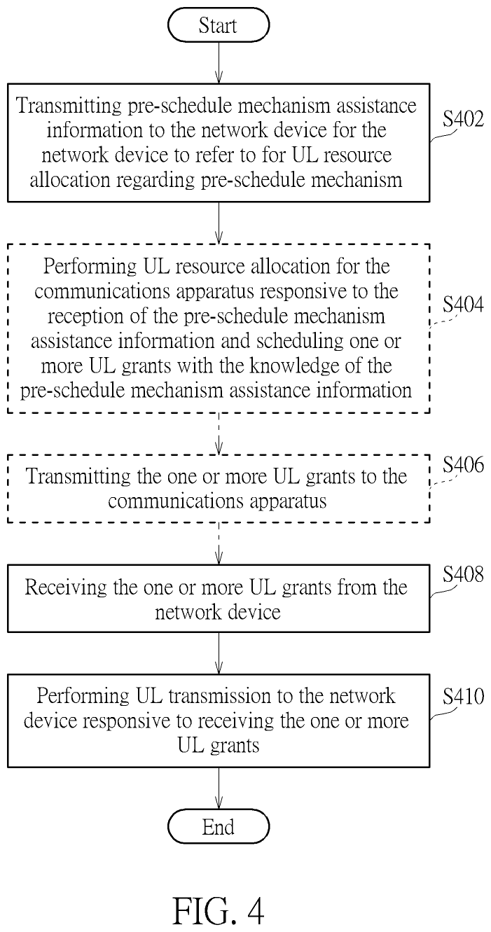

FIG. 4 illustrates an exemplary flow chart of a method for shortening latency associated with UL traffic transmission according to an embodiment of the invention. The method may be an example implementation of the proposed schemes described above with respect to improvement on UE uplink latency in wireless communications. The method may comprise the following steps performed by the communications apparatus 100 (as an example, the processor 222 of the communications apparatus 100):

Step S402: Transmitting pre-schedule mechanism assistance information to the network device for the network device to refer to for UL resource allocation regarding pre-schedule mechanism.

Step S408: Receiving one or more UL grants from the network device.

Step S410: Performing UL transmission to the network device responsive to receiving the one or more UL grants.

In an embodiment of the invention, the method may further comprise the following steps (drawn by dashed lines in FIG. 4 for distinction) performed by the network device 300 (as an example, the processor 320 of the network device 300):

Step S404: Performing UL resource allocation for the communications apparatus responsive to the reception of the pre-schedule mechanism assistance information and scheduling one or more UL grants for the communications apparatus with the knowledge of the pre-schedule mechanism assistance information.

Step S406: Transmitting the one or more UL grants to the communications apparatus 100 based on the UL resource allocation.

According to an embodiment of the invention, when the pre-schedule mechanism is enabled, the one or more UL grants may be actively and/or directly scheduled by the network device 300 based on no indication of UL transmission requirement. The indication of UL transmission requirement may comprise a request transmitted or provided by the communications apparatus 100, such as a scheduling request (SR) or a Buffer Status Report (BSR), for permission to perform an UL transmission. The SR and BSR are specified by the 3GPP standards and designed to be transmitted to the base station when there is uplink traffic (e.g., data packets) to be transmitted by the UE. In other words, in the embodiment of the invention, when the pre-schedule mechanism is enabled, the one or more UL grants are scheduled by the network device actively and/or directly, instead of being scheduled responsive to any indication of UL transmission requirement received from the communications apparatus 100.

According to an embodiment of the invention, the communications apparatus 100 may negotiate the pre-schedule mechanism assistance information support capability with the network device 300 in an attach procedure.

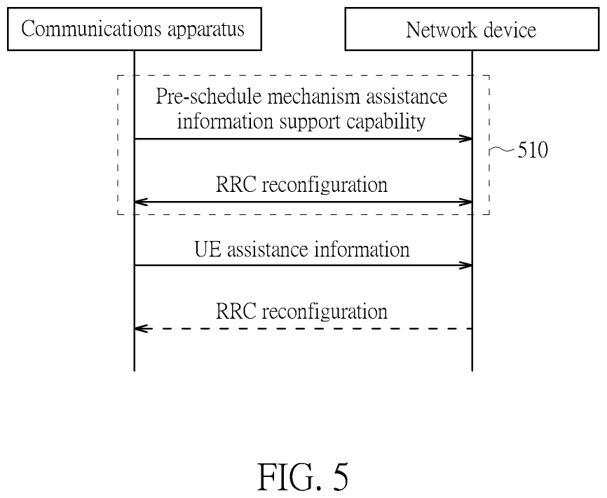

FIG. 5 is an exemplary message flow illustrating negotiation of the pre-schedule mechanism assistance information support capability and transmission of the pre-schedule mechanism assistance information according to an embodiment of the invention. Note that an attach procedure may be started when the communications apparatus 100 transmits an attach request message to the network device 300 and may be ended when communications apparatus 100 receives an attach accept message from the network device 300 and replies an attach complete message. As there may be plenty of messages to be transmitted between the communications apparatus 100 and the network device 300 during the attach procedure, those messages are omitted for brevity and only the messages relevant to the negotiation of the pre-schedule mechanism assistance information support capability are shown in the attach procedure 510.

According to an embodiment of the invention, during the attach procedure 510, the communications apparatus 100 may transmit an radio resource control (RRC) message comprising information regarding UE capability information to the network device 300, for informing the network device 300 about whether pre-schedule mechanism assistance information is supported by the communications apparatus 100. The network device 300 may also transmit an RRC reconfiguration message to the communications apparatus 100 for informing the communications apparatus 100 about whether pre-schedule mechanism assistance information is supported by the network device 300. When both the communications apparatus 100 and the network device 300 support pre-schedule mechanism assistance information, the communications apparatus 100 may transmit the pre-schedule mechanism assistance information to the network device 300. Upon receiving the pre-schedule mechanism assistance information, the network device 300 may determine the corresponding configurations based on the pre-schedule mechanism assistance information and provide the corresponding configurations to the communications apparatus 100 by transmitting an RRC reconfiguration message to the communications apparatus 100.

According to an embodiment of the invention, the pre-schedule mechanism assistance information provided by the communications apparatus 100 may carry information regarding an enable indicator indicating the network device to enable or disable the pre-schedule mechanism. Upon receiving the pre-schedule mechanism assistance information, the network device 300 may turn on or turn off the pre-schedule mechanism for the communications apparatus 100.

According to another embodiment of the invention, the pre-schedule mechanism assistance information provided by the communications apparatus 100 may carry information regarding resource allocation assistance information for the network device to refer to for UL resource allocation when pre-schedule mechanism is enabled, and the resource allocation assistance information may include a latency requirement (as an example, the “uplink latency” or “round trip latency” in millisecond) of the communications apparatus 100. Upon receiving the pre-schedule mechanism assistance information, the network device 300 may determine the arrangement of UL grants, the frequency of the UL grants or an interval between two UL grants based on the latency requirement.

According to yet another embodiment of the invention, the pre-schedule mechanism assistance information provided by the communications apparatus 100 may carry information regarding resource allocation assistance information for the network device to refer to for UL resource allocation when pre-schedule mechanism is enabled, and the resource allocation assistance information may include the resource requirement of the communications apparatus 100. The resource requirement of the communications apparatus 100 may include at least one of an interval or a suggested interval between two UL grants, a number or a suggested number of UL grants within a time interval and a size or a suggested size of UL grants required by the communications apparatus. As an example, upon receiving the pre-schedule mechanism assistance information, the network device 300 may determine the arrangement of UL grants, the frequency of the UL grants or the interval between two UL grants based on the suggested interval.

As another example, the pre-schedule mechanism assistance information provided by the communications apparatus 100 may carry information regarding a suggested number of UL grants to be scheduled within a time interval. Upon receiving the pre-schedule mechanism assistance information, the network device 300 may determine the arrangement of UL grants or the frequency of the UL grants based on the suggested number.

As another example, the pre-schedule mechanism assistance information provided by the communications apparatus 100 may carry information regarding a required transmission bandwidth, a suggested number of UL radio resources, and/or a suggested size of UL radio resources. Upon receiving the pre-schedule mechanism assistance information, the network device 300 may arrangement of UL grants and may configure the corresponding resources based on the required transmission bandwidth, the suggested number of UL radio resources, and/or the suggested size of UL radio resources.

In the embodiments of the invention, the communications apparatus 100 may actively transmit the pre-schedule mechanism assistance information to the network device 300, or the network device 300 may also actively query the communications apparatus 100 about the latency requirement or the resource requirement (e.g. the UL radio resource requirement). In this manner, the network device 300 may acquire the knowledge of UE's behavior and/or preference.

According to an embodiment of the invention, when the pre-schedule mechanism is enabled, the communications apparatus 100 may continuously or periodically receive UL grants from the network device 300 in response without any SR or BSR being transmitted. Consequently, as user data for UL transmission becomes available (e.g., user data arriving at layer 2 of the modem), the UE may directly perform UL transmission of packet(s) of user data with a short latency between the time of arrival of data for UL transmission at layer 2 and the time of UL transmission of such data due to early preparation of UL transmission resource(s).

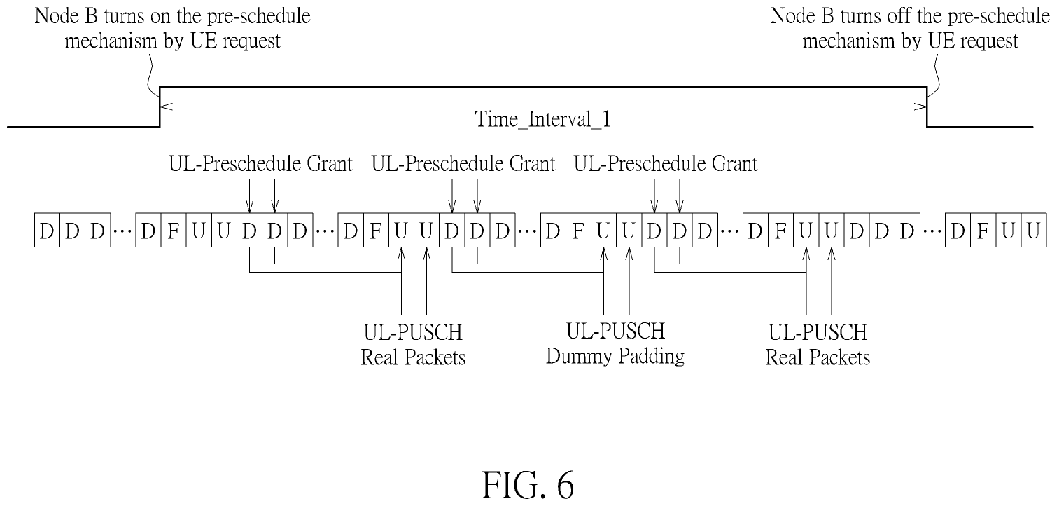

FIG. 6 illustrates an example scenario of resource scheduling associated with the proposed scheme according to an embodiment of the invention. The communications apparatus 100 may respectively carry pre-schedule mechanism assistance information with an enable indicator indicating an enablement request and pre-schedule mechanism assistance information with an enable indicator indicating a disablement request (e.g. the UE request as shown) at the beginning and the end of a time interval Time_Interval_1. In response, the network device 300 (e.g. the Node B) may turn on the pre-schedule mechanism during the time interval Time_Interval_1 by the enablement request indicated by the enable indicator and turn off the pre-schedule mechanism by the disablement request indicated by subsequent enable indicator.

In consequence, the communications apparatus 100 may receive one or more UL-preschedule grants (labeled by ‘D’ in FIG. 6, where the ‘D’ may refer to downlink traffic) during the time interval Time_Interval_1, and may perform UL transmission of packet(s) of user data (labeled by ‘U’ in FIG. 6, where the ‘U’ may refer to uplink traffic) in response to the UL-preschedule grants.

When an UL grant is received from the Node B and there is any data for UL transmission, the communications apparatus 100 may transmit the data in one or more UL-PUSCH (Physical Uplink Shared Channel) real packets. When an UL grant is received from the Node B and there is no data for UL transmission, the communications apparatus 100 may still transmit some information for UL traffic such as the UL-PUSCH dummy padding. For example, the communications apparatus 100 may transmit modem medium access control (MAC) padding, which may be configured as a frequency-based transmission parameter or a threshold configuration. As another example, the communications apparatus 100 may transmit modem layer 2 (L2) control data, retransmission data or an invalid protocol data unit (PDU). As yet another example, the communications apparatus 100 may transmit real networking dummy data such as, for example and without limitation, private Internet Protocol (IP) address data which would be dropped by any router upon receipt, an IP packet data designated for a predetermined IP address or a random IP address, with a time-to-live (TTL) value of the IP packet data less than a predefined TTL value, or a service data designated for a predetermined or specific server.

In this manner, the communications apparatus 100 may directly perform UL transmission of packet(s) of user data with a short latency between the time of arrival of data for UL transmission at layer 2 and the time of UL transmission of such data due to early preparation of UL transmission resource(s). As compared to the conventional approach shown in FIG. 3, since the UL grants may be pre-scheduled continuously by the network device 300 without the requirement of receiving any SR or BSR, the latency associated with UL traffic transmission, such as the latency in UE layer 2 (L2) shown in FIG. 3 is shortened or otherwise improved.

Note that different from the SR which is a physical signal with only 1 bit content, the pre-schedule mechanism assistance information is an RRC layer signaling with more than 1 bit content. As previously described, the content of pre-schedule mechanism assistance information may comprise the information regarding preferred transmission parameters, such as enable indicator and the resource allocation assistance information, such as the latency requirement and the resource requirement, and the preferred transmission parameters may be predefined with respect to the events that would trigger the enablement of the pre-schedule mechanism. Therefore, different from the usage of SR in which long latency in UE layer 2 will be generated as shown in FIG. 3 and the network may only response by scheduling the UL resources without any knowledge of UE's behavior or traffic information/requirement, with the pre-schedule mechanism assistance information, the latency in UE layer 2 is shortened and the network may further reconfigure the traffic and scheduling the UL resources with the knowledge of UE's behavior or traffic information/requirement.

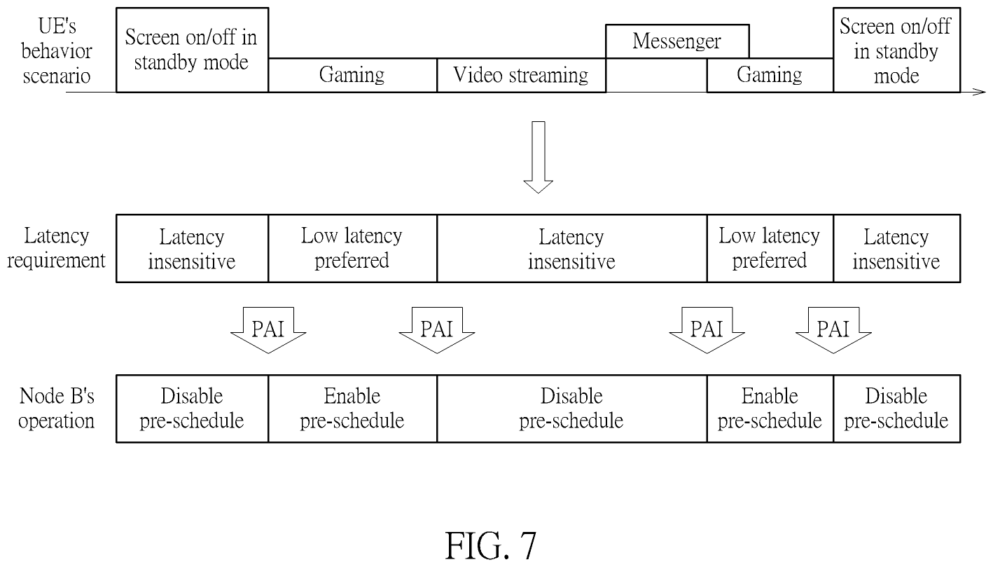

FIG. 7 is a schematic diagram showing the exemplary relations between the UE's behaviors and the latency requirements and the corresponding operations at the network side upon receiving the pre-schedule mechanism assistance information (abbreviated as PAI). In the upper portion of FIG. 7, UE's behavior scenarios are shown. In the middle portion of FIG. 7, the UE's latency requirements are shown. In the lower portion of FIG. 7, the Node B's operations are shown.

In the first scenario, the UE (e.g. the communications apparatus 100) operates in the standby mode with the screen being turned on or off and the latency requirement is latency insensitive since the user may not operate the UE very often. Therefore, the UE may not transmit PAI to the Node B (e.g. the network device 300) for requesting to enable a pre-schedule mechanism or may transmit PAI to the Node B for requesting to disable the pre-schedule mechanism (if it has been enabled), and the pre-schedule mechanism is now disabled.

In the second scenario, a game app on the UE is launched and the latency requirement becomes low latency preferred since the latency is a key factor influencing user experience. Therefore, in the embodiments of the invention, upon detection of any one of a plurality of predefined trigger events (as an example, in this scenario, launch of a game app on the UE), the UE transmits the PAI to the Node B (e.g. the network device 300) for requesting to enable a pre-schedule mechanism, and the pre-schedule mechanism is enabled at the Node B in response. Note that in some embodiments of the invention, the UE may further carry information regarding preferred transmission parameters with respect to the predefined trigger event in the PAI as described above. For example, the UE may further carry information regarding UE's latency requirement, the suggested interval between two UL grants, the suggested number of UL grants to be scheduled within a time interval, the required transmission bandwidth, the suggested number of UL radio resources, and/or the suggested size of UL radio resources with respect to the currently launched game app in the PAI.

In the third scenario, a video streaming app on the UE is launched and the latency requirement may be low latency preferred or latency insensitive, depending on the user's preference setting. In the embodiment shown in FIG. 7, the latency requirement of video streaming is set to latency insensitive. Therefore, when the game app is closed, the UE transmits PAI to the Node B for requesting to disable the pre-schedule mechanism, and the pre-schedule mechanism is disabled at the Node B in response.

In the fourth scenario, a messenger app on the UE is launched and the latency requirement may be low latency preferred or latency insensitive, depending on the user's preference setting. In the embodiment shown in FIG. 7, the latency requirement of video streaming is set to latency insensitive.

In the fifth scenario, a game app on the UE is launched again and the latency requirement becomes low latency preferred. Therefore, the UE transmits the PAI to the Node B for requesting to enable the pre-schedule mechanism, again, and the pre-schedule mechanism is enabled at the Node B in response. Note that in an embodiment of the invention, when there is more than one app launched at the same time, the latency requirements of the currently launched apps will be merged to come out a common latency requirement. In an embodiment of the invention, when latency requirements of the currently launched apps are merged, the low latency preferred app dominates the merged result (that is, dominates the latency requirement of the UE). Therefore, when the currently launched apps include a low latency preferred app, the current latency requirement of the UE is set to low latency preferred.

In the sixth scenario, the game app is closed and the UE operates in the standby mode with the screen being turned on or off. The UE transmits PAI to the Node B for requesting to disable the pre-schedule mechanism, and the pre-schedule mechanism is disabled at the Node B in response.

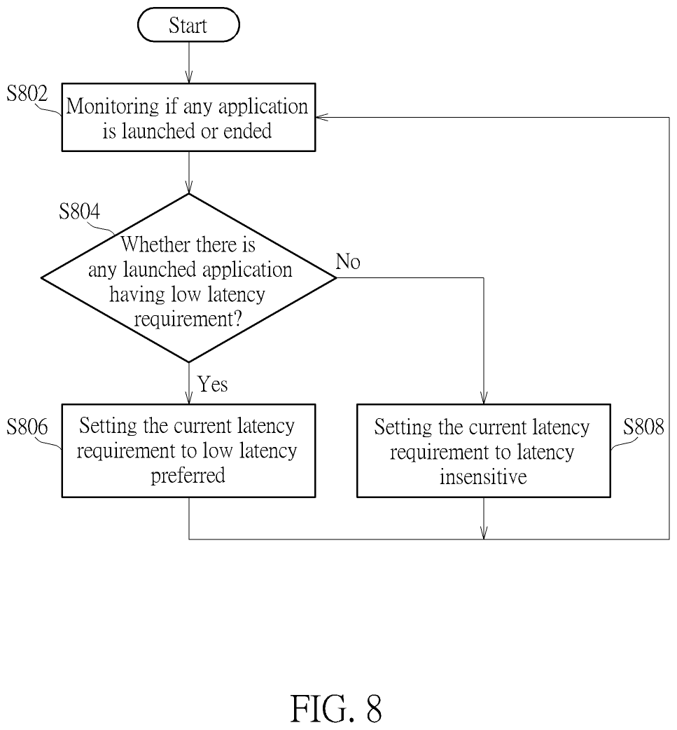

FIG. 8 illustrates an exemplary flow chart of a method for optimizing latency requirement based on detection of application scenario implemented at the UE side according to an embodiment of the invention. The method may comprise the following steps performed by the communications apparatus 100 (as an example, the processor 222 of the communications apparatus 100):

Step S802: Monitoring if any application is launched or ended.

Step S804: Determining whether there is any launched application having low latency requirement. If the determination result shows yes, step S806 is performed. If the determination result shows no, step S808 is performed.

Step S806: Setting the current latency requirement to low latency preferred. In response, the communications apparatus 100 transmits the PAI to the network device 300 for requesting to enable a pre-schedule mechanism.

Step S808: Setting the current latency requirement to latency insensitive. In response, the communications apparatus 100 may transmit the PAI to the network device 300 for requesting to disable the pre-schedule mechanism (if it has been enabled) or may not transmit any PAI to the network device 300 (if the pre-schedule mechanism is now disabled).

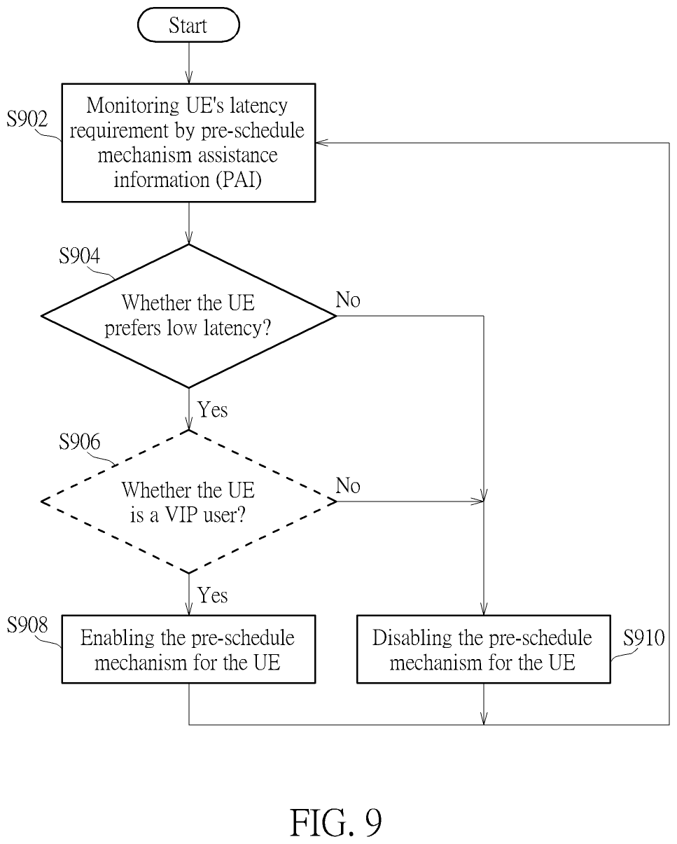

FIG. 9 illustrates an exemplary flow chart of a method for optimizing latency requirement based on detection of application scenario implemented at the Node B side according to an embodiment of the invention. The method may comprise the following steps performed by the network device 300 (as an example, the processor 320 of the network device 300):

Step S902: Monitoring UE's latency requirement by pre-schedule mechanism assistance information (PAI).

Step S904: Determining whether the UE (e.g. the communications apparatus 100) prefers low latency. If the determination result shows yes, step S906 is performed. If the determination result shows no, step S910 is performed.

Step S906: Determining whether the UE is a VIP user. If the determination result shows yes, step S908 is performed. If the determination result shows no, step S910 is performed. Note that since pre-scheduling of the UL radio resources will occupy network device's resource, the network device 300 may check if the UE is VIP (e.g. if the UE is a higher fee customer or if the UE has paid pre-schedule fee). Note further that Step S906 may be an optional step, and thus is drawn by dashed lines in FIG. 9 for distinction.

Step S908: Enabling the pre-schedule mechanism for the UE.

Step S910: Disabling the pre-schedule mechanism for the UE.

Note that in some embodiments of the invention, Step S902 may correspond to Step S402 for the network device 300 to receive the pre-schedule mechanism assistance information (PAI) from the communications apparatus, and step S904-S910 may be comprised in or arranged before the performance of step S404 for the network device 300 to perform UL resource allocation for the communications apparatus with the knowledge of the pre-schedule mechanism assistance information.

In the embodiments described above, the cost-effective, power-effective and resource-effective solutions to achieve improvement on UE uplink latency in wireless communications are proposed. Different from the conventional approaches in which the latency associated with UL traffic transmission is long and/or the power consumption at both the UE side and the bases station side is high and the radio resources are wasted when the UE does not have any actual UL data transmission request, with the proposed scheme being applied, the communications apparatus may lead the network device to schedule the UL grants in a more flexible and intelligent manner with the knowledge of UE's behavior, preference and/or traffic information/requirement. In this manner, not only improvement on UE uplink latency, but also improvement on power consumption and resource waste are achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communications apparatus, comprising:
a radio transceiver, transmitting or receiving wireless signals in a wireless network; and
a processor, coupled to the radio transceiver and configured to perform operations comprising:
transmitting pre-schedule mechanism assistance information to a network device in the wireless network for the network device to refer to for uplink (UL) resource allocation regarding a pre-schedule mechanism;
receiving one or more UL grants from the network device; and
performing UL transmission to the network device responsive to receiving the one or more UL grants.

2. The communications apparatus of claim 1, wherein the pre-schedule mechanism assistance information includes an enable indicator indicating the network device to enable or disable the pre-schedule mechanism.

3. The communications apparatus of claim 1, wherein the pre-schedule mechanism assistance information includes resource allocation assistance information for the network device to refer to for UL resource allocation when the pre-schedule mechanism is enabled.

4. The communications apparatus of claim 3, wherein the resource allocation assistance information includes latency requirement of the communications apparatus.

5. The communications apparatus of claim 3, wherein resource allocation assistance information includes resource requirement of the communications apparatus.

6. The communications apparatus of claim 5, wherein the resource requirement of the communications apparatus includes at least one of an interval between two UL grants, the number of UL grants within a time interval and size of UL grants required by the communications apparatus.

7. A method for shortening latency associated with UL traffic transmission, comprising:
transmitting, by a communications apparatus, pre-schedule mechanism assistance information to a network device in a wireless network for the network device to refer to for uplink (UL) resource allocation regarding a pre-schedule mechanism;
receiving, by the communications apparatus, one or more UL grants from the network device; and
performing, by the communications apparatus, UL transmission to the network device responsive to receiving the one or more UL grants.

8. The method of claim 7, wherein the pre-schedule mechanism assistance information includes an enable indicator indicating the network device to enable or disable the pre-schedule mechanism.

9. The method of claim 7, wherein the pre-schedule mechanism assistance information includes resource allocation assistance information for the network device to refer to for UL resource allocation when the pre-schedule mechanism is enabled.

10. The method of claim 9, wherein the resource allocation assistance information includes latency requirement of the communications apparatus.

11. The method of claim 9, wherein resource allocation assistance information includes resource requirement of the communications apparatus.

12. The method of claim 11, wherein the resource requirement of the communications apparatus includes at least one of an interval between two UL grants, the number of UL grants within a time interval and size of UL grants required by the communications apparatus.

13. A method for shortening latency associated with UL traffic transmission of a communications apparatus communicating with a network device in a wireless network, comprising:
receiving, by the network device, pre-schedule mechanism assistance information from the communications apparatus;
performing, by the network device, uplink (UL) resource allocation for the communications apparatus with the knowledge of the pre-schedule mechanism assistance information; and
transmitting, by the network device, one or more UL grants to the communications apparatus based on the UL resource allocation.

14. The method of claim 13, wherein the pre-schedule mechanism assistance information includes an enable indicator indicating the network device to enable or disable the pre-schedule mechanism.

15. The method of claim 14, wherein when the enable indicator indicates the network device to enable the pre-schedule mechanism, the method further comprises:
determining, by the network device, whether the communications apparatus is a VIP user;
enabling, by the network device, the pre-schedule mechanism for the communications apparatus when the communications apparatus is a VIP user; and
disabling, by the network device, the pre-schedule mechanism for the communications apparatus when the communications apparatus is not a VIP user.

16. The method of claim 13, wherein the pre-schedule mechanism assistance information includes resource allocation assistance information for the network device to refer to for the UL resource allocation when the pre-schedule mechanism is enabled.

17. The method of claim 16, wherein the resource allocation assistance information includes latency requirement of the communications apparatus.

18. The method of claim 16, wherein resource allocation assistance information includes resource requirement of the communications apparatus.

19. The method of claim 18, wherein the resource requirement of the communications apparatus includes at least one of an interval between two UL grants, the number of UL grants within a time interval and size of UL grants required by the communications apparatus.
